(19) United States
(12) Patent Application Publication
(10) Pub. No.: US 2016/0183352 A9
(43) Pub. Date: Jun. 23, 2016

(54) MULTI-ZONE CONTROL SYSTEM

(71) Applicant: Stuart RIGGS, Jacksonville, FL (US)

(72) Inventor: Stuart RIGGS, Jacksonville, FL (US)

(21) Appl. No.: 14/106,305

(22) Filed: Dec. 13, 2013

Related U.S. Application Data
(60) Provisional application No. 61/749,142, filed on Jan. 4, 2013.

(51) Int. Cl. H05B 37/02

(52) U.S. Cl. CPC H05B 37/0272; H05B 37/0218

(57) ABSTRACT

A multi-zone control system is provided. The multi-zone control system may include a system unit, zone wiring, a plurality of zone connection terminals and a first microcontroller. Each zone connection terminal may link at least one motion sensors and at least one security device to a first microcontroller. The first microcontroller may receive input when the at least one motion sensor detects movement of an occupant so as to activate the respective security device. A user may single-handedly install, operate and modify the multi-zone control system.

### CROSS-REFERENCE TO RELATED APPLICATION

This application claims the benefit of priority of U.S. provisional application number 61/749,142, filed Jan. 4, 2013, the contents of which are herein incorporated by reference.

### BACKGROUND OF THE INVENTION

The present invention relates to the field of security and lighting systems and, more particularly, to a security and lighting control system for multiple and separate zones involving the detection of light and/or occupancy in each zone.

Currently, many commercial lighting applications are used to illuminate multiple areas or zones of interest based on light and/or occupancy detection.

Translating these systems to residential use, currently, has also carried over the notorious difficulties of the commercial systems: complex installation/setup procedures, difficulties in modification and use, and expensive equipment requirements.

Another shortcoming of such multi-zone, light and motion sensing control systems is that they are not typically battery-powered. Eventually, overtime these batteries need to be replaced, but the energy cost saving benefits this maintenance. This is not an inconvenience from a maintenance perspective.

As can be seen, there is a need for a security and lighting control system that provides improved flexibility, performance as well as reducing the cost, complexity and installation/setup time of the system. It is also desirable to provide a system that is not limited to hard-wired connections.

### SUMMARY OF THE INVENTION

In one aspect of the present invention, a multi-zone control system comprises: a system unit comprising a power source, a first microcontroller and a plurality of zone connection terminals having a plurality of device connection terminals and a plurality of motion sensor connection terminals receiving a plurality of zone wiring; and a plurality of zones of interest having at least one security device and at least one motion sensor connected to the first microcontroller by the plurality of zone wiring, whereby the at least one motion sensor signals the first microcontroller when detecting at least one occupant moving within at least one zone of interest so that the first microcontroller activates the at least one security device within the respective zone of interest.

In another aspect of the present invention, method of customizing a multi-zone control system comprises: providing a multi-zone control system having a system unit comprising a power source, a first microcontroller and a plurality of zone connection terminals having a plurality of device connection terminals and a plurality of motion sensor connection terminals receiving a plurality of zone wiring; providing a plurality of zones of interest having at least one security device and at least one motion sensor connected to the first microcontroller by the plurality of zone wiring, whereby the at least one motion sensor signals the first microcontroller when detecting at least one occupant moving within at least one zone of interest so that the first microcontroller activates the at least one security device within the respective zone of interest; and adapting the system unit to disable at least one zone of interest where there are known occupants, thereby saving money by not unnecessarily operating occupied zones of interest.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention;

FIG. 3 is a top view of an exemplary embodiment of the present invention;

FIG. 4 is a back view of an exemplary embodiment of the present invention;

FIG. 5 is a top view of an exemplary embodiment of the present invention;

FIG. 6 is a side view of an exemplary embodiment of the present invention;

FIG. 7 is a side view of an exemplary embodiment of the present invention;

FIG. 8 is a system diagram of an exemplary embodiment of the present invention; and

FIG. 9 is a functional diagram of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-zone control system. The multi-zone control system may include a system unit, zone wiring, a plurality of zone connection terminals and a first microcontroller. Each zone connection terminal may link at least one motion sensors and at least one security device to a first microcontroller. The first microcontroller may receive input when the at least one motion sensor detects movement of an occupant so as to activate the respective security device. A user may single-handedly install, operate and modify the multi-zone control system.

In certain embodiments, the multi-zone control system may further include a light sensor circuit. In certain embodiments, the at least one security device may be an energy-saving lighting devices. The user may turn the system unit on by flipping a main power switch for nighttime use so as to save money by not using their standard lighting system but rather by allowing the motion sensors to turn on only the energy saving lighting devices when an occupant enters a zone of interest. In alternate embodiments, the light sensor circuit may automatically turn on the system unit when no daylight is detected or falls below a predetermined threshold level so that the user need not remember to turn on the multi-zone control system.

In certain embodiments, the multi-zone control system may further include at least one zone monitor. The activation of at least one security device and/or the detection of an occupant by its respective motion sensor may be indicated by the at least one zone monitor. The at least one zone monitor allows the user not in and/or near the activated zone of interest, to better determine the next course of security action to take. In certain embodiment, the user may turn off at least one zone of interest by using the at least one zone monitor so that known occupants do not activate the respective security devices.

In certain embodiments, the multi-zone control system may further include at a second microcontroller. In certain embodiments, the user may adjust the predetermined length of activation time of at least one security device connected to a zone connection terminal linked to the second microcontroller.

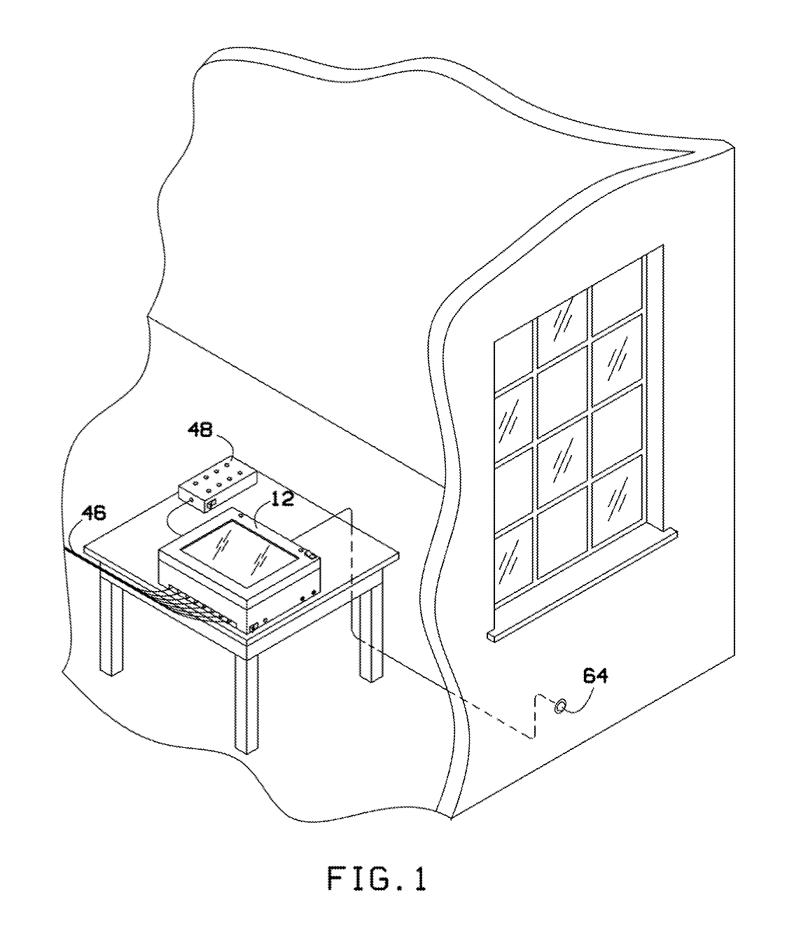

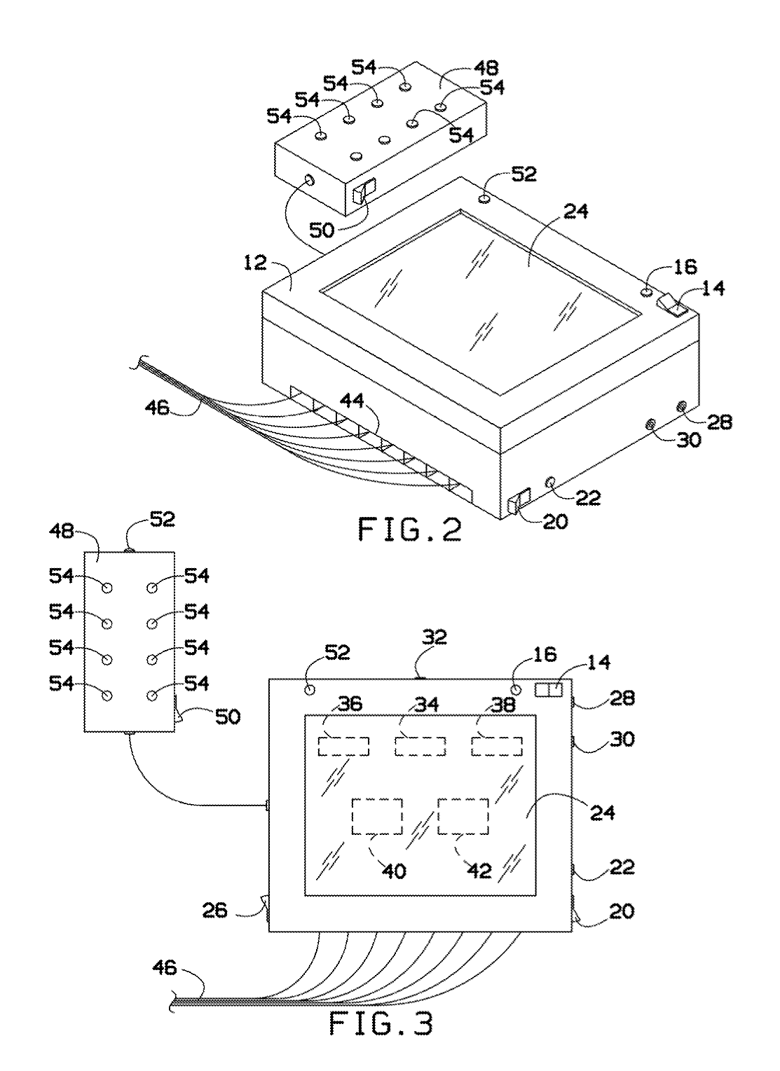

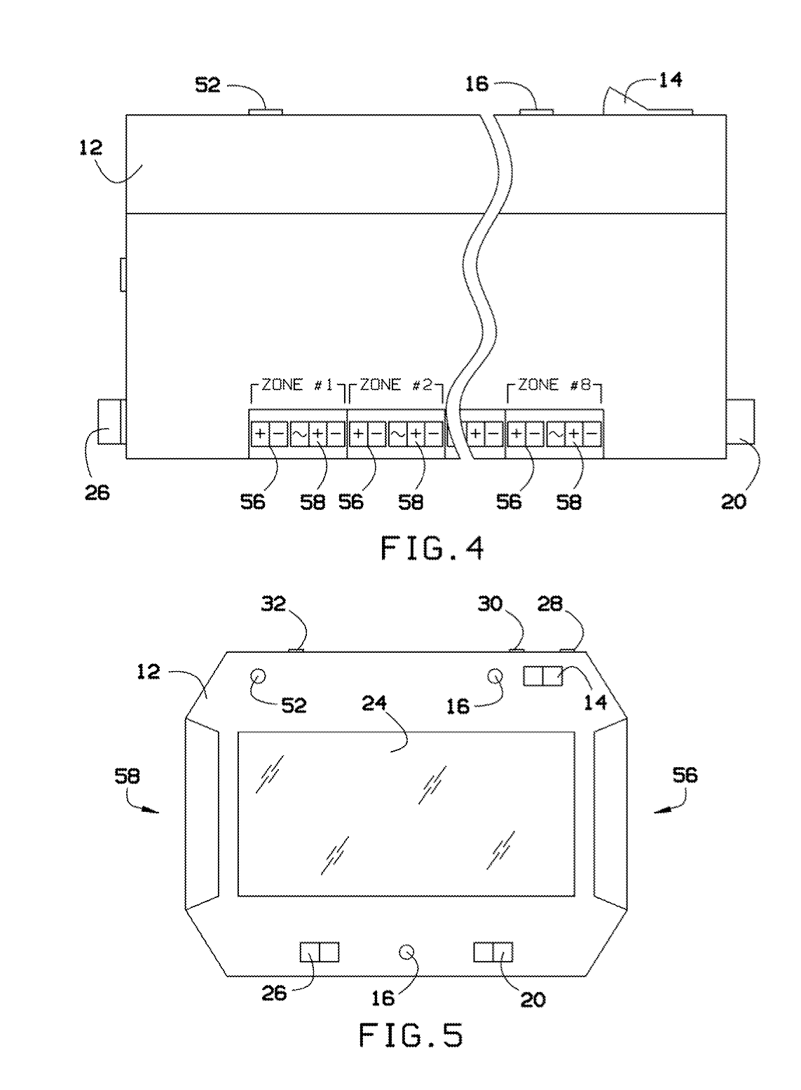

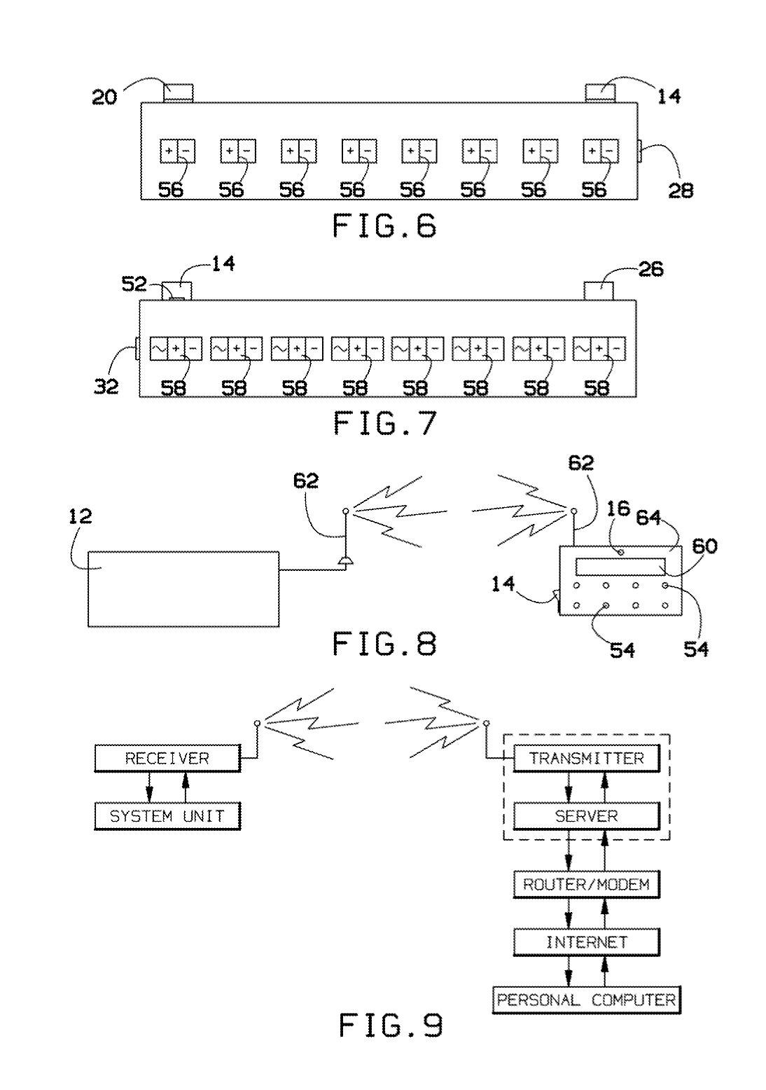

Referring to FIGS. 1 through 9, the present invention may include a multi-zone control system 100. The multi-zone control system 100 may include a system unit 12, a wired zone monitor 48 and a wireless zone monitor 64.

The system unit 12 may include a main power switch 14, a power indicator 16, a test switch 20, a test indicator 22, a transparent window 24, an interior light switch 26, a power connector 28, a battery connector 30, a light sensor connector 32, a light sensor circuit 34, at least one high power transistors 36, at least one fuse 38, a first microcontroller 40, a second microcontroller 42, an antenna 62, zone wiring 46 and a plurality of zone connection terminals 44. Each zone connection terminal 44 may include a device connection terminal 56 and a motion sensor connection terminal 58 for receiving the zone wiring 46.

The multi-zone control system 100 may include a plurality of zones of interest. Each zone of interest may be associated with a separate zone connection terminal 44. Each zone of interest may include at least one security device and at least one motion sensor connected to the associated zone connection terminal 44 by the zone wiring 46.

The at least one security device may include 12 volt devices, lights, buzzers, speakers and the like. In certain embodiments, the lights may include emitting diodes (LEDs), LED strips, power-saving lights and the like. In certain embodiments, the speakers may include piezo speakers. The at least one motion sensor may detect movement of an occupant within the zone of interest.

The first microcontroller 40 may link each at least one motion sensor to each at least one security device within each respective zone connection terminal 44. Therefore, when a motion sensor detects movement of an occupant within the respective zone of interest, the linked at least one security device may be activated for a predetermined length of time. In certain embodiments, the system unit 12 may include an activation component configured to activate and deactivate each zone connection terminal 44 independently.

The first microcontroller 40 may be connected to the light sensor circuit 34 and to the at least one high power transistors 36. The light sensor circuit 34 may be connected to a light sensor via the light sensor connector 32. In certain embodiments, the light sensor circuit 34 may include a light resistor (LDR) sensor circuit. The light sensor circuit 34 may automatically turn on when no daylight is detected or falls below a predetermined threshold level. In certain embodiments, the first microcontroller 40 may turn on the system unit 12 when the light sensor circuit 34 turns on.

The second microcontroller 42 may be connected to at least one zone connection terminal 44, wherein linking the at least one motion sensor to the at least one security device. The second microcontroller 42 may adjust the length of time the at least one security device may be activated for. In certain embodiments, the second microcontroller 42 may use pulse width modulation to dim down to off the at least one security device.

The wired zone monitor 48 may include a zone monitor switch 50 and a plurality of zone indicators 54. Each zone indicator 54 may be dedicated to a separate zone connection terminal 44 so that when the respective at least one security device activated and/or the at least one motion sensor stimulated by motion, the zone indicator 54 may be activated. The wired zone monitor 48 may be configured to activate and deactivate each zone connection terminal 44 independently.

The wireless zone monitor 64 may include a main power switch 15, a power indicator 17, a plurality of zone indicators 55, a LCD display 60, and an antenna 63. The wireless zone monitor 64 antenna 63 may send signals to the system unit 12 antenna 62. Each zone indicator 55 may be dedicated to a separate zone connection terminal 44 so that when the respective at least one security device activated and/or the at least one motion sensor stimulated by motion, the zone indicator 55 may be activated. The wired zone monitor 64 may be configured to activate and deactivate each zone connection terminal 44 independently. In certain embodiments, the plurality of zone indicators 55 may be viewed on a LCD display 60. The system unit 12 may be turned on by the main power switch 14.

The power indicator 16 may indicate if the system unit 12 is on. The system unit 12 may be powered by batteries located in the battery connector 30 and/or by connection to an external power source via the power connector 28. The test switch 20 may activate the at least one motion sensor when the multi-zone control system 100 may be disabled. The test indicator 22 may indicate that at least one motion sensor may be receiving power when the test switch 20 is on.

In certain embodiments, the system unit 12 may connect the interior light switch 26 to an internal light so that the inside of the system unit 12 can be seen through the transparent window 24. The system unit 12 may include the at least one fuse 38 so as to protect and reduce damage to the system unit 12. The system unit 12 may apply the first microcontroller 40 and the second microcontroller 42 so as to ensure better dedicated operation.

A method of using the present invention may include the following. The multi-zone control system 100 disclosed above may be provided. A user may turn the system unit 12 on by flipping of the main power switch 14. In certain embodiments, the user need not remember to turn on the unit system 12 as the light sensor circuit 34 may automatically turn on the system unit 12 when no daylight is detected or falls below a predetermined threshold level. In certain embodiments, when the at least one motion sensor detects movement of an occupant in a zone of interest, the first microcontroller 40 may activate the respective at least one security device.

In certain embodiments, the plurality of security devices may be energy-saving lighting sources so that the user may rely on the plurality of security devices to provide light, thereby saving energy by foregoing turning on more energy-costly light sources when traveling into the plurality of zones of interest.

In certain embodiments, activation of at least one of the plurality of security devices and/or the detection by at least one of the plurality of motion sensors may be indicated by the wired zone monitor 48 and the wireless zone monitor 64, thereby enabling the user not in and/or near the activated zone of interest to better determine the next course of security action. In certain embodiment, the user may deactivate zone connection terminals 44 independently by using the wired zone monitor 48 and the wireless zone monitor 64 so that known occupants do not activate the dedicated security devices.

In certain embodiments, the user may adjust the predetermined length of activation time for the at least one security device linked to the second microcontroller 42. For example, when the user may anticipate needing additional time at a front door to pull out keys and find the lock, the user may connect the respective zone connection terminal 44 to the second microcontroller 42, and make the time adjustment accordingly.

It should be understood, of course, that the foregoing relates to exemplary embodiments of the invention and that modifications may be made without departing from the spirit and scope of the invention as set forth in the following claims.

What is claimed is:

1. A multi-zone control system comprising:
a system unit comprising a power source, a first microcontroller and a plurality of zone connection terminals, wherein each zone connection terminal comprises a security device connection terminal and a motion sensor connection terminal; and
at least one security device and at least one motion sensor connected to the first microcontroller through one of the plurality of zone connection terminals, thereby linking the at least one motion sensor and the at least one security device, whereby the at least one motion sensor signals the first microcontroller when detecting motion, and the first microcontroller activates the at least one security device linked to the at least one motion sensor.

2. The multi-zone control system of claim 1, further comprising at least one zone monitor comprising an indicator, wherein the indicator is activated by the activation of the at least one motion sensor.

3. The multi-zone control system of claim 2, wherein the at least one zone monitor is wireless

4. The multi-zone control system of claim 1, wherein the system unit further comprises an activation component connected to each zone connection terminal independently.

5. The multi-zone control system of claim 1, further comprising a light sensor circuit connected to the system unit, wherein the light sensor circuit is configured to detect daylight and activate or deactivate the system unit based on a predetermined threshold level of light.

6. The multi-zone control system of claim 1, further comprising a second microcontroller connected to at least one zone connection terminal, wherein the second microcontroller is configured to adjust the length of activation time of the at least one security device connected to the at least one zone connection terminal.

7. The multi-zone control system of claim 1, wherein the at least one security device includes energy-saving lighting.

8. The multi-zone control system of claim 1, wherein the power source is a battery.

9. A method of constructing a lighting system comprising:
providing a system unit comprising a power source, a first microcontroller and a plurality of zone connection terminals, wherein each zone connection terminal comprises a security device connection terminal and a motion sensor connection terminal
providing at least one security device and at least one motion sensor linked together by the first microcontroller through each zone connection terminal, whereby the at least one motion sensor signals the first microcontroller when detecting motion, and the first microcontroller activates the at least one security device linked to the at least one motion sensor; and mounting the at least one security device and the at least one motion sensor within a zone of interest.

10. A method of claim 9, further comprising the steps of:
connecting a second security device and a second motion sensor to a zone connection terminal; and
mounting the second security device and the second motion sensor within a second zone of interest.
